(19) United States
(12) Patent Application Publication
(10) Pub. No.: US 2021/0239834 A1
(43) Pub. Date: Aug. 5, 2021

(54) OPTICAL RANGING APPARATUS AND OPTICAL RANGING METHOD

(71) Applicant: DENSO CORPORATION, Kariya-City (JP)

(72) Inventors: Teiyu KIMURA, Kariya-City (JP); Kenichi YANAI, Kariya-City (JP); Shinji KASHIWADA, Kariya-City (JP)

(21) Appl. No.: 17/239,055

(22) Filed: Apr. 23, 2021

Related U.S. Application Data
(63) Continuation of application No. PCT/JP2019/041332, filed on Oct. 21, 2019.

(30) Foreign Application Priority Data
Oct. 25, 2018 (JP) 2018-200540

(51) Int. Cl. G01S 17/10; G01S 7/481; G02B 27/14; G02B 26/10

(52) U.S. Cl. CPC G01S 17/10; G01S 7/4814; G02B 26/101; G02B 27/14; G01S 7/4817

(57) ABSTRACT

The laser light for performing a detection for at least 2 pixel parts is scanned in a first direction, covering at least a predetermined angle of field range. A reflection body is driven to reflect the scanned laser light, to scan the laser light in a second direction, covering a predetermined external range. The reflected light from the object is turned towards a light receiving lens by a route changing unit. A light receiving unit provided with a light receiving element for at least 2 pixel parts detects a condensed reflected light from the object. The distance to the object is detected depending on a period from a time when the laser light is emitted to a time when the reflected light is received. The route changing unit is disposed allowing the laser light scanned in the first direction to pass therethrough to reach the reflection body.

This application is the U.S. bypass application of International Application No. PCT/JP2019/041332 filed Oct. 21, 2019 which designated the U.S. and claims priority to Japanese Patent Application No. 2018-200540, filed Oct. 25, 2018, the contents of which are incorporated herein by reference.

### BACKGROUND

### Technical Field

The present disclosure relates to a technique for optically measuring a distance to an object using laser light.

### Description of the Related Art

A ranging technique is known for measuring a distance to an object in which laser light is projected in a predetermined region and the time for detecting the reflected light is detected, thereby measuring the distance.

### SUMMARY

The present disclosure provides an optical ranging apparatus using laser light. The optical ranging apparatus is provided with an emission unit; a first scanning unit; a reflection body; a second scanning unit; a route changing unit; a light receiving unit; and a ranging unit. The first scanning unit is provided between the emission unit and the route changing unit. The first scanning unit, the route changing unit and the second scanning unit are arranged in positions where the laser light from the first scanning unit passes through the route changing unit to reach the second scanning unit.

### BRIEF DESCRIPTION OF THE DRAWINGS

In the accompanying drawings:

FIG. 1 is a diagram showing an overall configuration of an optical ranging apparatus according to a first embodiment;

FIG. 2 is an explanatory diagram showing a configuration of a light receiving element;

FIG. 3 is an explanatory diagram showing the theory of an optical ranging;

FIG. 4 is an explanatory diagram showing a relationship between the scanning range and the light receiving element;

FIG. 5 is a flowchart showing a regional detecting routine;

FIG. 6 is an explanatory diagram showing an example of a regional detection;

FIG. 7 is an explanatory diagram showing a main part of other embodiment; and

FIG. 8 is an explanatory diagram showing a main part of other embodiment.

### DETAILED DESCRIPTION OF THE PREFERRED EMBODIMENTS

A ranging technique is known for measuring a distance to an object in which laser light is projected in a predetermined region and the time for detecting the reflected light is detected, thereby measuring the distance. In such a ranging technique, there have been some attempts, for example, Japanese Patent No. 4810763 discloses a configuration, to measure a distance to an object for a wide area by two-dimensionally scanning the laser light.

Although the above-described disclosure discloses a superior technique for measuring a distance to an object in a wide area, further downsizing is required to apply the technique for various mobile bodies such as vehicles, or a facility. In order to achieve such a requirement of downsizing, an optical system is required to be downsized. In the case where two-dimensional scanning is applied to a required region, the optical system becomes complex causing the mirror or a prism for the scanning to increase in size, and increasing the processing load of signal processing for measuring the distance.

With reference to the drawings, embodiments of the present disclosure will be described.

### EMBODIMENTS

### A1. Hardware Configuration of a First Embodiment

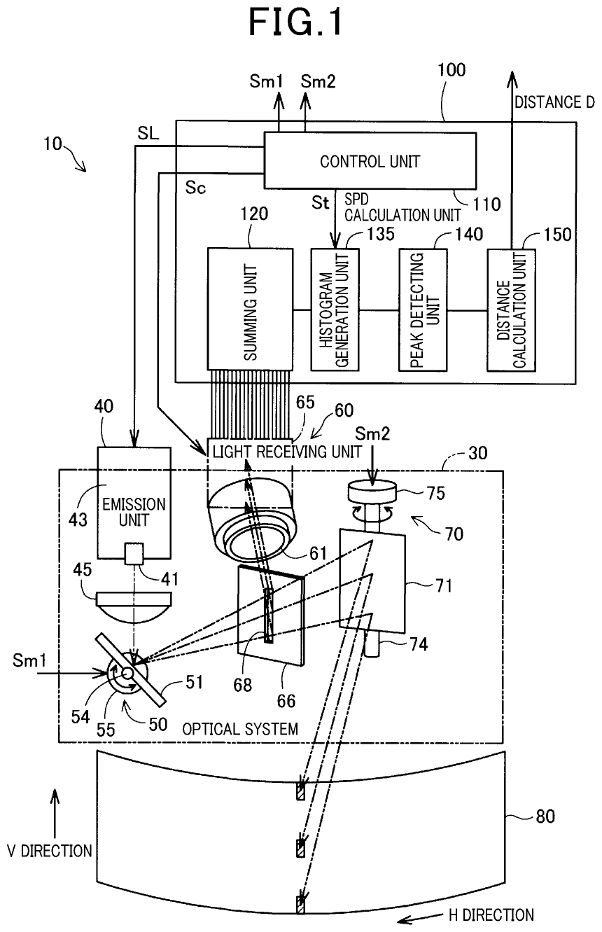

As shown in FIG. 1, an optical ranging apparatus 10 is provided with an optical system 30 transmitting a laser light to an object and receiving reflected light, and a SPAD calculation unit 100 performing ranging. The optical system 30 is provided with an emission unit 40, V-direction scanning unit 50 corresponding to a first scanning unit, a light receiving unit 60 and an H-direction scanning unit 70 corresponding to a second scanning unit.

The emission unit 40 is provided with a laser element 41 that emits laser light for the ranging, a circuit substrate 43 including a drive circuit of the laser element 41 and a collimator lens 45 that converts the laser light emitted from the laser light to be parallel light. The laser element 41 is configured as a laser diode capable of producing a so-called short pulse laser, where the pulse width of the laser light is approximately 5 nsec. A short pulse of 5 nsec is used, thereby improving the ranging resolution. Also, the laser element 41 includes three light emission elements arranged in one direction. Hence, the laser light to be emitted for ranging has a longitudinal shape in one direction. As described later, the longitudinal shape direction of the laser light is defined as a vertical direction (also referred to as V direction) when emitting the laser light for the ranging.

A V-direction scanning unit 50 is provided with a surface reflection mirror 51 that reflects the laser light converted to the parallel light by the collimator lens 45, a rotary shaft 54 that pivotally supports the surface reflection mirror 51 and a rotary solenoid 55 rotationally drives the rotary shaft 54. The rotary solenoid 55 repeatedly rotates forward and reversely, in response to a control signal Sm1 received from outside, the forward rotation and reverse rotation being within a predetermined angular range (hereinafter referred to as angle of field range). As a result, the rotary shaft 54 and also the surface reflection mirror 51 rotate within this angular range. Accordingly, incident laser light from the laser element 41 via the collimator lens 45 scans a predetermined angle of field range in the vertical direction (V direction).

In this scanning range, a combiner 66 corresponding to a route changing unit is provided. The combiner 66 is a reflection mirror in which an opening 68 is provided at the center thereof. The laser light scanned by the surface reflection mirror 51 in the vertical direction passes the opening 68 and enters the surface reflection mirror 71 of the H-direction scanning unit 70. The combiner 66 is a fixed reflection mirror in which the reflection surface is in the back surface side in FIG. 1. The laser light passing through the opening 68 of the combiner 66 is reflected at the surface reflection mirror 71 of the H-direction scanning unit 70 and transmitted externally. In the H-direction scanning unit 70, a rotary shaft 74 that pivotally supports the surface reflection mirror 71 and a rotary solenoid 75 that rotatably drives the rotary shaft 74 are provided other than the surface reflection mirror 71. The rotary solenoid 75 repeatedly rotates forward and reversely, in response to a control signal Sm2 received from outside, within a predetermined angular range. As a result, the rotary shaft 74 and also the surface reflection mirror 71 rotates within this angular range. Accordingly, incident laser light via the opening 68 scans a predetermined angle of field range in the horizontal direction (H direction).

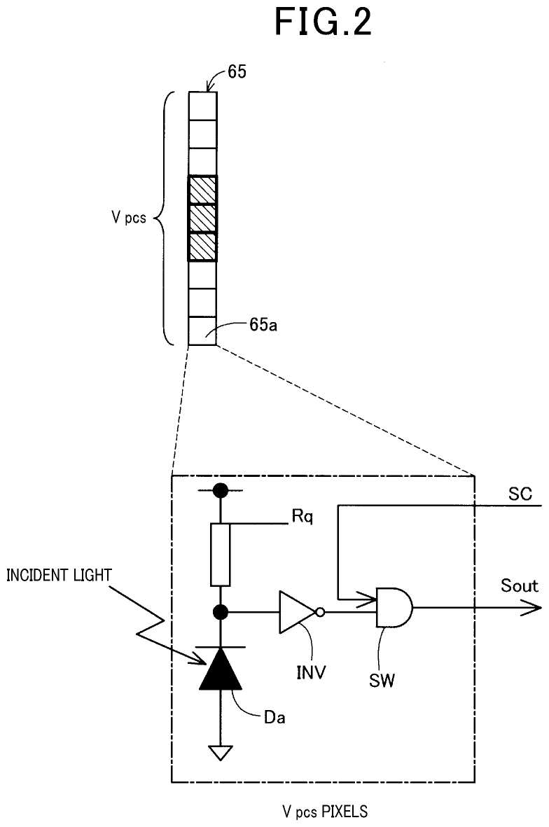

Two surface reflection mirrors 51 and 71 are driven within a predetermined range, whereby the laser light emitted from the emission unit 40 scans in the vertical direction (V direction) and the horizontal direction (H direction). Hence, the laser light to be externally emitted from the optical ranging apparatus 10 scans the scanning range 80 which is schematically shown in FIG. 1 in the V direction and the H direction. In the case where an object such as a personor a vehicle is present in the scanning range 80, the laser light is randomly reflected at the surface and a part of the reflected light returns towards the H direction scanning unit 70. The reflected light is reflected at the surface reflection mirror 71, returned towards the combiner 66 and reflected at the surface of the combiner 66, thereby proceeding to the light receiving unit 60. The reflected light reflected at the mirror surface of the combiner 66 is made incident into a light receiving lens 61 of the light receiving unit 60, condensed by the light receiving lens 61, and made incident into a light receiving array 65 in which the light receiving elements 65a shown in FIG. 2 are arranged.

According to the optical system 30 of the present embodiment, the laser element 41 serves as a laser element having a longitudinal light emission angle. The light emission angle of the laser element 41 corresponds to the field angle of view corresponding to 3 pixel parts of the light receiving element 65a of the light receiving unit 60. The vertical direction in this case refers to a V direction in the scanning range 80. In FIG. 1, the vertical direction when viewed on the paper surface corresponds to the vertical direction of the light emission angle of the laser element 41. The longitudinal laser light is scanned on the surface reflection mirror 71 in the vertical direction (V direction) such that the laser light reflected at the surface reflection mirror 71 scans the scanning range 80 in the V direction. On the other hand, the surface reflection mirror 71 of the H direction scanning unit 70 rotates forward and reversely within a predetermined angle of field view range, the laser light elongated in the V direction scans the scanning range 80 in the H direction.

As described, the longitudinal laser light is able to scan the scanning range 80 by the V direction scanning unit 50 and the H direction scanning unit 70. The laser light which scanned the scanning range 80 is reflected by the object OM and travels the above-described path to enter the light receiving element 65a of the light receiving unit 60. The light receiving array 65 includes, as exemplified in FIG. 2, a plurality of light receiving elements 65a arranged in the vertical direction. The size of the arrangement of the light receiving elements 65a corresponds to a maximum range (V direction angle of field view) scanned by the scanning unit 50 in the V direction. For the light receiving element 65a, an avalanche photo diode (APD) is used to achieve high response and excellent sensitivity. When the reflected light (photon) enters the APD, a pair of an electron and hole are generated, then the electron and hole are each accelerated by a high electric field causing subsequent impact ionization to generate new pairs of electrons and holes (avalanche phenomenon). Thus, since the APD is capable of enhancing incident photons, APD is likely to be utilized in the case where the intensity of the reflected light is small such as the case of an object present in the distance. The operational mode of the APD includes a linear mode for operating at a reverse bias voltage which is less the breakdown voltage, and a Geiger mode for operating at a reverse voltage which is larger than or equal to the breakdown voltage. In the linear mode, the number of pairs of electrons and holes lost from the high electric field region is larger than that of the generated pairs of electrons and holes so that the breakdown caused by generation of the pair of electrons and holes is naturally terminated. Accordingly, an amount of the output current from the APD is approximately proportional to an amount of incident light.

On the other hand, in the Geiger mode, an avalanche phenomenon can be produced even with a single incident photon. Hence, the detection sensitivity can be further improved. The APD operating in such a Geiger mode may be referred to as a single photon avalanche diode (SPAD).

In each light receiving element 65a, as shown in an equivalent circuit of FIG. 2, a quench resistor Rq and an avalanche diode Da are connected in series between the power source Vcc and the ground line, and the voltage at the connection point is received by an inverting element INV as one of logic gates and converted to an inverted digital signal. Since the output of the inverting element INV is connected to either one input of an AND circuit SW, when the input at the other input is high level H, the output signal of the inverting element INV is transmitted externally without any change. The state of the other input of the AND circuit SW can be changed by a selection signal SC. The selection signal SC is used to specify which light receiving element 65a of the light receiving array 65 is to be used to read the corresponding signal therefrom. Hence, the selection signal SC may be referred to as an address signal. In the case where an avalanche diode is used in the linear mode and the output thereof is used as an analog signal, an analog switch may be used instead of using the AND circuit SW. Further, a PIN photo diode can be used instead of using the avalanche diode Da.

In the case where no light is made incident on the light receiving element 65a, the avalanche diode Da is kept in a non-conduction state. Hence, the input side of the inverting element INV is kept at a state of being pulled up via the quench resistor Rq, that is, high level H. Hence, the output of the inverting element INV is kept at low level L. When external light is made incident on the respective light receiving elements 65a, the avalanche diode Da enters a conduction state due to the incident light (photon). As a result, a large amount of current flows through the quench resistor Rq, and the input side of the inverting element INV temporarily becomes low level L, and then the output of the inverting element INV is inverted to high level H. In the case where a large amount of current flows through the quench resistor Rq, since the voltage applied to the avalanche diode Da is lowered, the power supplied to the avalanche diode Da is stopped and the state of the avalanche diode Da returns to the non-conduction state. As a result, the output signal of the inverting element INV is also inverted to return to the low level L. Consequently, when the light (photon) is made incident on the respective light receiving elements 65a, high level pulse signal is outputted for a very short period of time. In this respect, the address signal SC is controlled to be high level H at a timing where each of the light receiving elements 65a receives the light, whereby the output signal of the AND circuit SW, that is, the output signal Sout from each light receiving elements 65a indicates the state of the avalanche diode Da.

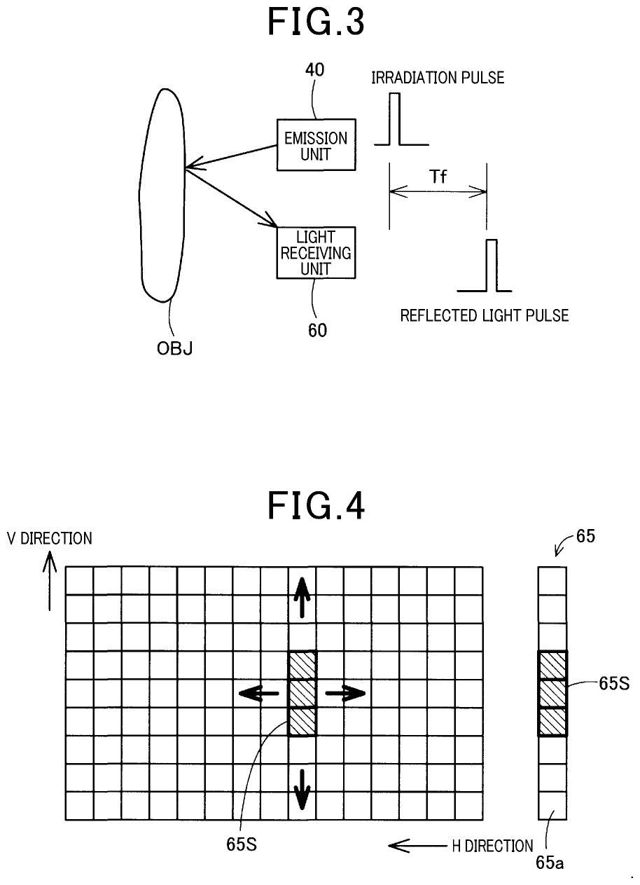

The output Sout of each light receiving element 65a is produced in the case where the light emitted by the laser element 41 is reflected at an object OBJ existing in the scanning range 80 and returned to the light receiving unit 60. Hence, as shown in FIG. 3, a period Tf from a time when the emission unit 40 is driven to output the laser light (hereinafter referred to irradiation light pulse) to a time when the reflected light pulse reflected at the object OBJ is detected by each light receiving element 65a of the light receiving unit 60 is measured, whereby the distance to the object can be detected. The object OBJ may be present at various locations from the vicinity of the optical ranging apparatus 10 to distant therefrom. Therefore, the scanning range 80 shown in FIG. 1 does not show that long and short distance of the optical ranging apparatus 10 is uniform, but schematically show the scanning range by the laser light.

As described above, the light receiving element 65a outputs a pulse signal when receiving the reflected light. The pulse signal outputted by the light receiving element 65a is transmitted to the SPAD calculation unit 100 which corresponds to a ranging unit. The SPAD calculation unit 100 calculates the distance to the object OBJ in accordance with a period from a time when the laser element 41 outputs the irradiation light pulse to a time when the light receiving array 65 of the light receiving unit 60 receives the reflected light pulse, while making the laser element 41 emit light to scan external space. The SPAD calculation unit 100 includes a known CPU and a memory unit, and executes programs prepared in advance to perform necessary processes for the ranging. Specifically, the SPAD calculation unit 100 is provided with a summing unit 120, a histogram generation unit 135, a peak detecting unit 140, a distance calculation unit 150 and the like other than the control unit 110 performing an overall control.

The summing unit 120 is a circuit that sums outputs of a large number of receiving elements included in a single light receiving element 65a. FIG/ 2 is illustrated assuming that a single output Sout is present in a single light receiving element 65a. However, N×N pcs of light receiving elements (N is 2 or more natural number) are provided in the single light receiving element 65a. When the reflected light is made incident on the light receiving element 65a, N×N pcs of elements operate. According to the present embodiment, 7×7 pcs of SPAD are provided in the single light receiving element 65a. Note that the number of SPADs or arrangements can be modified in various manners such as 5×9 pcs instead of 7×7 pcs.

The light receiving element 65a is configured of a plurality of SPADs. This is because of the characteristics of a SPAD. The SPAD is capable of detecting only one photon being incident. However, the detection of the SPAD from a limited quantity of light of the object OM is a stochastic detection. The summing unit 120 of the SPAD calculation unit 100 sums the output signal Sout from the SPAD which is only able to stochastically detect the reflected light, thereby reliably detecting the reflected light.

The histogram generation unit 135 receives the reflected light pulse (FIG. 3) thus obtained. The histogram generation unit 135 generates the histogram by summing the summing result of the summing unit 120 for multiple times. The signal detected by the light receiving element 65a contains noise. However, by summing the signals from the respective light receiving elements 65a corresponding to the plurality of irradiation light pulses, the signals corresponding to the reflected light pulses are accumulated but the signals corresponding to noise are not accumulated. Accordingly, the signals corresponding to the reflected light pulse are clearly extracted. In this regard, the histogram generated by the histogram generation unit 135 is analyzed, and the peak detecting unit 140 detects the peak. The peak of the signal is none other than the reflected light pulse shown in FIG. 3. The peak is thus detected. Then, the distance calculation unit 150 detects the period Tf from the irradiation light pulse to the peak of the reflected light pulse, whereby the distance D to the object can be detected. The detected distance D is outputted to an automatic driving apparatus or the like in the case where the optical ranging apparatus 10 is mounted on the automatic driving vehicle. Further, the optical ranging apparatus 10 can be utilized as a ranging apparatus mounted on a mobile body such as a drone, a vehicle and a boat, or a fixed ranging apparatus.

The control unit 110 outputs a command signal SL to the circuit board 43 of the emission unit 40 for determining an emission timing of the laser element 41, an address signal Sout for determining which light receiving element 65a to be active, and further a signal St to the histogram generation unit 135 indicating the generation timing of the histogram, and drive signals Sm1 and Sm2 to the rotary solenoids 55 and 75 of the V-direction scanning unit 50 and the H-direction scanning unit 70. The control unit 110 outputs these signals at a predetermines timing, whereby the SPAD calculation unit 100 detects an object OBJ possibly present in the scanning range 80 and together with the distance D to the object OBJ.

A2. Scanning of the Irradiation Light Pulse:

Next, with the above-described hardware configuration, a method for scanning the scanning range 80 with the irradiation light pulse will be described. FIG. 4 is an explanatory diagram showing a relationship between the scanning range 80 and the light receiving unit 60. According to the present embodiment, the light receiving array 65 includes a plurality of light receiving elements 65a (9 elements in FIG. 4) arranged in the vertical direction. An alignment of the optical system 30 is adjusted such that reflected light is made incident on 3 light receiving elements in the plurality of light receiving elements with one irradiation pulse. A group of 3 light receiving elements 65a where the reflected light is made incident is referred to as a light receiving area 65S. In this state, when the control unit 110 drives the V-direction scanning unit 50 with the drive signal Sm1, the light receiving area 65S moves towards the V-direction with respect to the scanning range 80. This movement is expressed by arrows V1 and V2. Further, when the control unit 110 drives the H-direction scanning unit 70 with the signal Sm2, this movement is expressed by arrows H1 and H2. Further, even when driving the H-direction scanning unit 70 so as to change the angle of field range of the surface reflection mirror 71, the incident position of the reflected light on the light receiving array 65 is not changed in the H-direction. Accordingly, in the light receiving array 65, only one element is prepared in the H direction corresponding to one pixel part. On the other hand, when changing the angle of field range of the surface reflection mirror 51 by driving the V-direction scanning unit 50, the incident position of the reflected light moves on the light receiving array 65 towards the V direction. This is because the light receiving unit 60 including the combiner 66 is provided between the V-direction scanning unit 50 and the H-direction scanning unit 70. Hence, the light receiving elements 65a are prepared corresponding to a plurality of pixel parts in the V direction. The light receiving elements 65a may be prepared for a plurality of pixel parts in the H direction and combined with the light receiving elements 65a prepared for a plurality of pixel parts in the V direction so as to form a single block for the scanning. Moreover, light receiving elements other than the light receiving area 65S may be set to be OFF, or may operate to measure the ambient light.

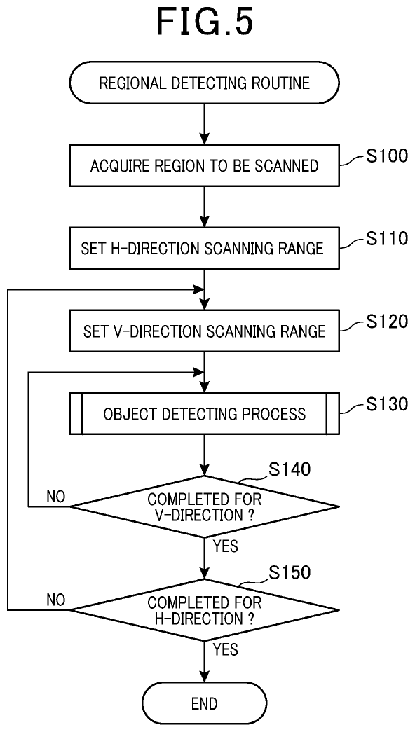

With the above-described optical system 30, the SPAD calculation unit 100 executes a regional detecting routine shown in FIG. 5. When starting the routine shown in FIG. 5, the SPAD calculation unit 100 acquires a region to be scanned (step S100). The region to be scanned refers to a region to which the irradiation light pulse is outputted by driving the optical system 30. The scanning range 80 shown in FIG. 1 shows an example in which the region to be scanned is a substantially rectangular shape. According to the present embodiment, this scanning region is not limited to a substantially rectangular shape but may be set in advance. The scanning range may be set by the SPAD calculation unit 100 or may be given by external equipment such as an automatic driving apparatus.

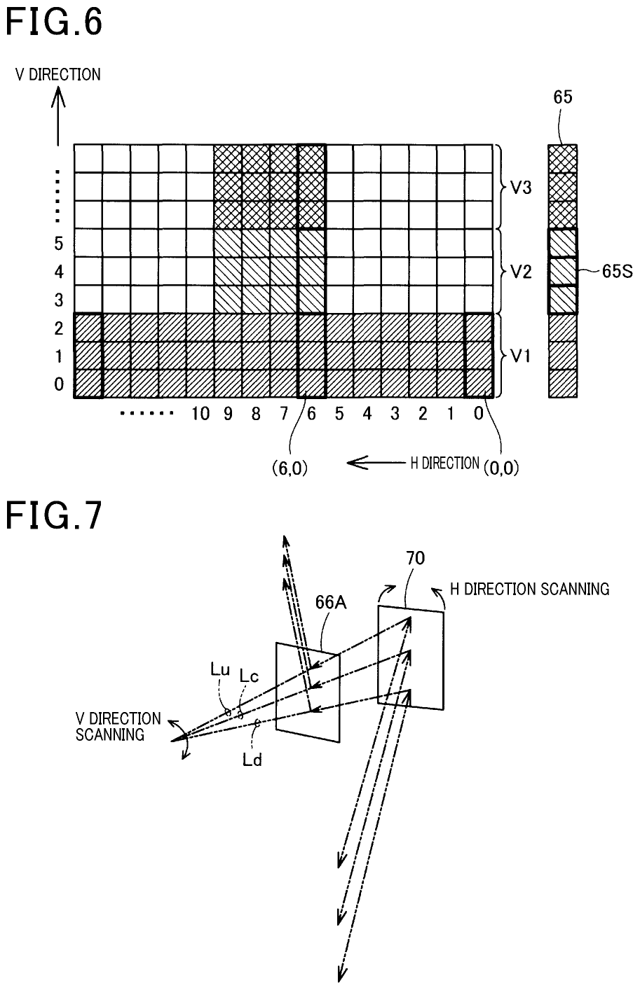

An example of such a scanning region is shown in FIG. 6. In this example, the scanning region 80 is divided into three regions in the V direction. The region corresponding to the lowest region V1 is entirely scanned in the H direction, and the region corresponding to the middle region V2 and the region corresponding to the highest region V3 are scanned at only a predetermined center region. According to the present embodiment, the scanning range 80 is scanned in the V direction first and scanned in the H direction next. Accordingly, when the scanning region is scanned, the scanning range in the H direction is set (step S110). In this example, the H-direction scanning range is defined from one end to the other end of the scanning range. When setting the scanning range in the H direction, the SPAD calculation unit 100 controls the V direction scanning unit 50 and the H direction scanning unit 70, thereby setting the lighting position of the laser light to be the origin, that is, right bottom position (0, 0) of the scanning range 80 in FIG. 6.

Subsequently, the scanning range in the V direction is set (step S120). In the example shown in FIG. 6, the scanning range in the V direction at the origin is a range V1. Next, an object detecting process is executed (step S130). In other words, the laser light is driven at this position to output the irradiation light pulse and detect the reflected light from the object OBJ, thereby detecting presence of the object OBJ together with the distance D.

Next, the process determines whether the detection process for the V direction is completed (step S140). In the case where the detection for the detection range (range V1) set for the V direction is not completed, the process outputs the drive signal sm1 to the V-direction scanning unit 50 to slightly rotate the surface reflection mirror 51 for scanning the region V1 in the V direction, thereby continuing the detection of the object OBJ. When completing the scanning and the detection in the V direction at a position in the H direction (step S140: YES), the process subsequently determines whether the scanning in the H direction is completed (step S150). In the case where the scanning in the H direction is not completed (step S150: NO), the process outputs the drive signal Sm2 to the H direction scanning unit 70 to slightly rotate the surface reflection mirror 71 to move the lighting position of the laser light towards the H direction. Moreover, the process sets the scanning range in the V direction again (step S120).

In an example shown in FIG. 6, the region V1 is scanned in the V direction while changing the lighting position towards the H direction, thereby continuing the detection of object OBJ (acquisition of distance D). When the scanning in the H direction is advanced to reach the position (6, 0), the V direction scanning range is set to be regions V1, V2 and V3 (step S120). In this respect, the detection process of the object OM (step S130) and the scanning of the lighting position in the V direction using the V direction scanning unit 50 are repeatedly performed until the detection process in the V direction is completed (step S140: YES). As a result, the regions V1, V2 and V3 are sequentially scanned. The reflected light from these regions are detected by corresponding light receiving elements 65a of the light receiving array 65. When the lighting region of the laser light changes in the V direction, the incident position of the reflected light on the light receiving array 65 also changes to the V direction.

Thus, according to an example shown in FIG. 6, the scanning range in the V direction is set to be regions V1 to V3 for the positions (6,0) to (9,0) in the H direction. When the position in the H direction becomes (10, 0), the scanning range in the V direction is limited to the region V1 again. Thus, in the case where the scanning is performed over a wide area in the V direction for the region set in advance while scanning in the H direction, and the scanning position reaches the end portion of the H direction, the determination at step S150 becomes YES, proceeding to the END and the process is terminated.

As described above, according to the optical ranging apparatus 10 of the present embodiment, the combiner 66 is disposed between the V-direction scanning unit 50 and the H-direction scanning unit 70, the V-direction scanning unit 50 changes the direction of the laser light in the V direction at a portion closer to the laser element 41 than the combiner 66 is, and the H-direction scanning unit 70 changes the laser light in the H direction after the laser light passes the opening 68 of the combiner 66. Therefore, in the scanning range 80, the irradiation range of the laser light can be changed in the V direction and the H direction. Accordingly, the angle of field of the scanning light scanning in both directions can be expanded. Further, since the laser light irradiated at a time corresponds to 3 pixel parts, the light receiving unit 60 which receives this laser light is also able to perform the ranging for 3 pixel parts at a time. Therefore, wide area ranging can be performed within a short period of time.

Further, according to the present embodiment, since the longitudinal laser light is used from the beginning, the surface reflection mirror 71 which scans in the H direction is not necessarily expanded even when the angle of field is expanded in the V direction. Further, since a short pulse laser having narrow pulse width of light emission pulse is used for the laser element 41 and SPAD is used for the light receiving element 65a, the detection accuracy can be improved. Moreover, since the emission period of the irradiation light pulse can be shorter, external disturbance caused by excessive light entering into the light receiving unit 60 during the ranging operation can be avoided. Furthermore, since the combiner 66 having the opening 68 is used for separating the irradiation light and the reflected light, the irradiation light can be prevented from entering the light receiving unit 60 when the irradiation light is reflected at the combiner 66. Also, in this regard, influence of external disturbances in the ranging operation can be avoided.

Also, according to the above-described embodiment, since the range in which the irradiation light pulse is capable of being irradiated can be set arbitrarily in either H direction or the V direction, it is limited to a part of the scanning range 80. Hence, it is not necessary to perform the ranging operation for an unnecessary range where the ranging operation is not required. For example, the ranging operation is not necessarily performed for a portion capable of being determined as the sky when viewed from the vehicle. Hence, a time required for scanning the unnecessary range can be utilized for repetitive ranging for the ranging region. If the number of repetitive ranging is increased, the measurement accuracy can be improved for that. For example, according to an example shown in FIG. 6, a center ranging area is expanded in the V direction. However, a time allocated for an omitted scanning area where ranging is not applied for V2 and V3 regions in the left and right portions can be applied for the ranging of the center ranging area. This can be applied for a case where the ranging accuracy of the center portion of the scanning range 80 is required to be enhanced, when travelling on a highway. Alternatively, when making a right or a left turn, the ranging may preferably be performed through wider area with higher accuracy for a side where the vehicle is turning, compared to those of the other side.

B. Second Embodiment:

According to the first embodiment, the combiner 66 is formed to have a planar shape.

However, the combiner 66 may have a shape of concave mirror. The concave mirror may be used as a part of the optical system in which the reflected light forms an image on the light receiving array 65 of the light receiving unit 60. Then, the optical system of the light receiving unit 60 can be downsized. For example, when the optical system of the light receiving unit 60 is configured of 4 lenses, the most outer concave lens among them can be replaced by a concave mirror of the combiner 66. Hence, a configuration of the lens of the light receiving unit 60 can be downsized. Since the combiner 66 of the above-described embodiment utilizes the opening 68 for allowing the irradiation light pulse to pass through, it is preferable to use the the concave mirror instead of combiner 66 since the laser light in the irradiation side is prevented from being influenced by the concave mirror.

C. Third Embodiment:

According to the first embodiment, the combiner 66 having the opening 68 is used. However, the configuration allowing the laser light in the irradiation side to pass through is not limited to the opening. As exemplified in FIG. 7, an optical component having a function that transmits light from one direction and reflects light from the opposite side such as a half mirror can be utilized. In the example shown in FIG. 7, a half mirror is utilized as the combiner 66A. As shown in FIG. 7, when the laser light in the irradiation side is vertically scanned in the V direction from the center Lc, the laser light passes a range from the upper most line Lu to the lower most line Ld. The angle formed between Ld and Lu is defined as an angle of field in the V direction. According to the first embodiment, the opening 68 has a length corresponding to the angle of field range. In contrast, in the optical system shown in FIG. 7, the combine 66A adopts the half mirror so that the opening is not necessarily provided. The laser light passes through the combiner 66a, and is reflected at the surface reflection mirror 71 to be irradiated to the scanning range 80, then the laser light is reflected at the object and returned. The returned reflected light is reflected at the surface reflection mirror 71, and reflected at the surface of the combiner 66A to enter the light receiving unit 60. Also in this case, similar to the first embodiment, a wide angle field can be accomplished with a small sized configuration. Hence, the ranging operation can be performed with a wider scanning range.

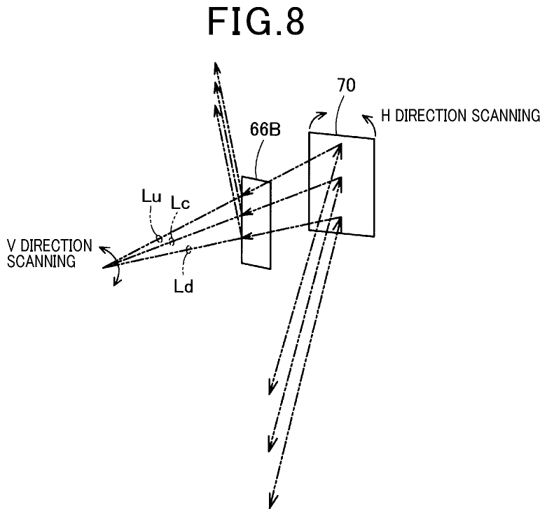

D. Other Embodiments:

[1] Instead of using the combiner 66 provided with the opening in the first embodiment, as shown in FIG. 8, a half-sized combiner 66B can be used. As shown in FIG. 8, when vertically scanning the laser light of the irradiation side from the center Lc in the V direction, the laser light passes through a range from the upper most line Lu to the lower most line Ld. The angle formed between Ld and Lu is defined as an angle of field in the V direction. The light in the range passes a portion immediately close to the combiner 66B, is reflected at the surface reflection mirror 71 to be irradiated to the scanning range 80 and returns to the object. The reflected light is reflected at the surface reflection mirror 71, then enters the portion where the combiner 66B is present, and reflected at the surface of the combiner 66B to enter the light receiving unit 60. Also in this case, similar to the first embodiment, the wide angle field can be accomplished with a small sized configuration. Hence, the ranging operation can be performed with a wider scanning range.

[2] According to the present embodiment, the V-direction scanning unit 50 and the H-direction scanning unit 70 are disposed such that the combiner 66 is disposed therebetween. However, the V-direction scanning unit 50 and the H-direction scanning unit 70 may be disposed in the opposite direction. Further, the arrangement shown in FIG. 1 may be rotated by 90 degrees to change between the V-direction and the H-direction. Note that V-direction scanning unit 50 and the H-direction scanning 70 may be independently scanned, and the shape of the scanning range 80 is not necessarily limited to a specific shape. Also, in the case where the emission unit emitting the laser light is able to scan the laser light for 2 pixel parts in 2 directions and the light receiving unit is able to detect for at least 2 pixel parts, the combiner 66 and the half mirror or the like may not be provided.

[3] According to the above-described embodiments, 3 emission elements are used such that the laser light from the laser element 41 has a wide angle of field in the V direction. However, a laser element having a long emission surface in one direction may be used with a single laser element 41 so as to enlarge the angle of field. The angle of field of the laser element 41 is not limited to for 3 pixel parts, but for 2 pixel parts of the light receiving element 65a. Further, with the laser element having a wide angle of field in the V direction, respective units for executing the processes of signals from respective light receiving units, such as the summing unit 120, the histogram generation unit 135, the peak detecting unit 140, and the distance calculation unit 150 may be prepared corresponding to the number of light receiving units 65a that simultaneously receive the reflected light, and ranging operation may be parallelly performed for at least respective light receiving elements 65a. Since the laser light of the laser element 41 has a wide angle of field and the reflected light from the object simultaneously returns to the light receiving unit 60, parallel processing can be performed. When the parallel processing is performed, the process for the same scanning range 80 can be completed in a short period of time compared to a case where the parallel processing is not performed.

[4] In the above-described embodiments, a part of the configuration accomplished by hardware may be replaced by software. Also, a part of the configuration accomplished by software may be accomplished by a configuration of discrete circuits. In the case where a part or all of the functions of the present disclosure is accomplished by software, the software (i.e. computer program) can be provided being stored in a computer readable recording media. The computer readable recording media is not limited to a portable recording media such as a flexible disk and a CD-ROM, but includes an internal memory device in the computer such as RAM or ROM, and an external memory unit fixed to the computer such as a hard disk or the like. In other words, the computer readable recording media includes various recording media capable of not temporarily recording but permanently recording data packets.

The present disclosure is not limited to the above-described embodiments, but can be accomplished as various configurations without departing from the spirit of the disclosure. For example, technical features in the embodiments corresponding to the technical features described in the summary section can be appropriately replaced or combined to solve the above-described part of or all of problems or achieve a part of or all of above-described effects and advantages. Further, in the case where the technical features are not described as necessary elements, corresponding technical features can be omitted. For example, the present disclosure may be accomplished with the following aspects.

### CONCLUSION

According to the optical ranging apparatus of the present disclosure, the ranging operation can be performed changing irradiation range of the laser light in the first direction and the second direction so that the angle of field of light to be scanned in both directions can be expanded. Further, the laser light irradiated at one time is for at least 2 pixels parts, and the light receiving unit that receives the laser light is able to receive the laser light for at least 2 pixels at one time. Hence, the ranging can be performed for a plurality of locations at one time. As a result, the ranging can be performed for wider range within a short period of time.

(1) One aspect of the present disclosure is an optical ranging apparatus using laser light. The optical ranging apparatus is provided with an emission unit that emits laser light to perform a detection for at least 2 pixel parts in a predetermined direction; a first scanning unit that scans the laser light in a first direction corresponding to the predetermined direction, covering at least a predetermined angle of field range; a reflection body that reflects the laser light scanned by the first scanning unit; a second scanning unit that scans the laser light in a second direction intersecting the first direction, covering a predetermined external range and receives reflected light from an object existing in the predetermined external range; a route changing unit provided in a middle of a path from the reflection body of the second scanning unit to the first scanning unit, turning the reflected light from the object towards a light receiving lens; a light receiving unit provided with a light receiving element for at least 2 pixel parts, detecting the reflected light from the object which is condensed by the light receiving lens; and a ranging unit that detects a distance to the object depending on a period from a time when the emission unit emits the laser light to a time when the light receiving unit receives the reflected light from the object. The first scanning unit is provided between the emission unit and the route changing unit. The first scanning unit, the route changing unit and the second scanning unit may be arranged in positions where the laser light from the first scanning unit passes through the route changing unit to reach the second scanning unit.

(2) In the optical ranging apparatus as described above, the route changing unit may be configured as a combiner provided with an opening or a slit through which the laser light passes; and the opening or the slit may have a length corresponding to the angle of field range of the laser light from the first scanning unit. Thus, a configuration in which the laser light scanned in the first direction can be scanned by the reflection body in the second direction, and the reflected light is turned towards the light receiving lens can readily be accomplished.

(3) In the optical ranging apparatus as described above, the route changing unit may be configured as a half mirror that allows the laser light to pass therethrough and reflects the reflected light from the second scanning unit towards the light receiving lens. Hence, the route changing unit can readily be configured.

(4) In the optical ranging apparatus as described above, a short pulse laser may be used for an emission element of the emission unit. Thus, a resolution of the ranging can be enhanced.

(5) In the optical ranging apparatus as described above, the route changing unit may be configured as a concave mirror serving as a part of the light receiving lens that condenses the reflected light from the object towards the light receiving unit. Thus, the lenses of the light receiving unit can be configured with one fewer lens so that the optical system of the light receiving unit can be downsized.

(6) In the optical ranging apparatus as described above, the first scanning unit and the second scanning unit may be capable of being independently driven. Thus, the range of the ranging can be independently set for the first direction and the second direction. Alternatively, the predetermined external range may have a predetermined shape defined by the first direction and the second direction which are combined in advance. Thus, the ranging can be effectively performed for a required range.

(7) In the optical ranging apparatus as described above, further, signals from the light receiving element for at least 2 pixel parts may be processed in parallel. Since the ranging can be performed for at least 2 pixels at the same time, the processing speed of the ranging can be faster.

(8) A second aspect of the present disclosure is an optical ranging method for optically measuring a distance.

The optical ranging method includes: emitting laser light to perform a detection for at least 2 pixel parts in a predetermined direction; scanning the laser light in a first direction corresponding to the predetermined direction, covering at least a predetermined angle of field range; driving a reflection body that reflects the scanned laser light; scanning the laser light in a second direction intersecting the first direction, covering a predetermined external range and receiving a reflected light from an object existing in the predetermined external range; turning the reflected light from the object towards a light receiving lens by a route changing unit provided in a middle of a path from the reflection body reflecting the reflected light from the object to an upper stream side; detecting, with a light receiving unit provided with a light receiving element for at least 2 pixel parts, the reflected light from the object which is condensed by the light receiving lens; and detecting a distance to the object depending on a period from a time when the laser light is emitted to a time when the light receiving unit receives the reflected light from the object. The laser light may be scanned in an upper stream side of the route changing unit in the first direction, covering the predetermined angle of field range; and the route changing unit may be disposed allowing the laser light scanned in the first direction covering the predetermined angle of field range to pass through the route changing unit. According to the optical ranging method, the ranging operation can be performed changing irradiation range of the laser light in the first direction and the second direction so that the angle of field of light to be scanned in both directions can be expanded. Further, the laser light irradiated at one time is for at least 2 pixels parts, and the light receiving unit that receives the laser light is able to receive the laser light for at least 2 pixels at one time. Hence, the ranging can be performed for a plurality of locations at one time. As a result, the ranging can be performed for wider range within a short period of time.

(9) A third aspect of the present disclosure is an optical ranging method for optically measuring a distance.

The optical ranging method includes: emitting laser light to perform a detection for at least 2 pixel parts in a predetermined direction; scanning the emitted laser light in a first direction corresponding to the predetermined direction, covering at least a predetermined angle of field range; scanning the scanned laser light in a second direction intersecting the first direction, covering a predetermined external range and detecting, with a light receiving unit provided with a light receiving element for at least 2 pixel parts, a reflected light from an object existing in the predetermined external range; and detecting a distance to the object depending on a period from a time when the laser light is emitted to a time when the light receiving unit receives the reflected light from the object. According to the optical ranging method, the ranging operation can be performed changing irradiation range of the laser light in the first direction and the second direction so that the angle of field of light to be scanned in both directions can be expanded. Further, the laser light irradiated at one time is for at least 2 pixels parts, and the light receiving unit that receives the laser light is able to receive the laser light for at least 2 pixels at one time. Hence, the ranging can be performed for a plurality of locations at one time. As a result, the ranging can be performed for wider range within a short period of time.

What is claimed is:

1. An optical ranging apparatus using laser light comprising:
an emission unit that emits laser light to perform a detection for at least 2 pixel parts in a predetermined direction;
a first scanning unit that scans the laser light in a first direction corresponding to the predetermined direction, covering at least a predetermined angle of field range;
a reflection body that reflects the laser light scanned by the first scanning unit;
a second scanning unit that scans the laser light in a second direction intersecting the first direction, covering a predetermined external range and receives a reflected light from an object existing in the predetermined external range;
a route changing unit provided in a middle of a path from the reflection body of the second scanning unit to the first scanning unit, turning the reflected light from the object towards a light receiving lens;
a light receiving unit provided with a light receiving element for at least 2 pixel parts, detecting the reflected light from the object which is condensed by the light receiving lens; and
a ranging unit that detects a distance to the object depending on a period from a time when the emission unit emits the laser light to a time when the light receiving unit receives the reflected light from the object,
wherein
the first scanning unit is provided between the emission unit and the route changing unit; and
the first scanning unit, the route changing unit and the second scanning unit are arranged in positions where the laser light from the first scanning unit passes through the route changing unit to reach the second scanning unit.

2. The optical ranging apparatus according to claim 1, wherein
the route changing unit is configured as a combiner provided with an opening or a slit through which the laser light passes; and
the opening or the slit has a length corresponding to the angle of field range of the laser light from the first scanning unit.

3. The optical ranging apparatus according to claim 1, wherein
the route changing unit is configured as a half mirror that allows the laser light from the first scanning unit to pass therethrough and reflects the reflected light from the second scanning unit towards the light receiving lens.

4. The optical ranging apparatus according to claim 1, wherein
a short pulse laser is used for an emission element of the emission unit.

5. The optical ranging apparatus according to claim 1, wherein
the route changing unit is configured as a concave mirror serving as a part of the light receiving lens that condenses the reflected light from the object towards the light receiving unit.

6. The optical ranging apparatus according to claim 1, wherein
the first scanning unit and the second scanning unit are capable of being independently driven.

7. The optical ranging apparatus according to claim 1, wherein
the predetermined external range has a predetermined shape defined by the first direction and the second direction which are combined in advance.

8. The optical ranging apparatus according to claim 1, wherein
signals from the light receiving element for at least 2 pixel parts are further processed in parallel.

9. An optical ranging method for optically measuring a distance comprising:
emitting laser light to perform a detection for at least 2 pixel parts in a predetermined direction;
scanning the laser light in a first direction corresponding to the predetermined direction, covering at least a predetermined angle of field range;
driving a reflection body that reflects the scanned laser light;
scanning the laser light in a second direction intersecting the first direction, covering a predetermined external range and receiving reflected light from an object existing in the predetermined external range,
turning the reflected light from the object towards a light receiving lens by a route changing unit provided in a path from the reflection body reflecting the reflected light from the object to an upper stream side;
detecting, with a light receiving unit provided with a light receiving element for at least 2 pixel parts, the reflected light from the object which is condensed by the light receiving lens; and
detecting a distance to the object depending on a period from a time when the laser light is emitted to a time when the light receiving unit receives the reflected light from the object,
wherein
the laser light is scanned in an upper stream side of the route changing unit in the first direction, covering the predetermined angle of field range; and
the route changing unit is disposed allowing the laser light scanned in the first direction covering the predetermined angle of field range to pass through the route changing unit.
